(19) United States
(12) Patent Application Publication
(10) Pub. No.: US 2011/0058088 A1
(43) Pub. Date: Mar. 10, 2011

(54) IMAGE-CAPTURING MODULE WITH A FLEXIBLE TYPE SUBSTRATE STRUCTURE

(76) Inventors: Chi-Hsing HSU, Xindian (TW); Chih-Chien Chen, Xindian (TW)

(21) Appl. No.: 12/686,945

(22) Filed: Jan. 13, 2010

(30) Foreign Application Priority Data
Sep. 9, 2009 (TW) 98216630

(51) Int. Cl. H04N 5/225

(52) U.S. Cl. 348/335; 348/E05.024

(57) ABSTRACT

An image-capturing module with a flexible type substrate structure includes a substrate unit, an image-capturing unit, an optical imaging unit, a light-emitting unit and a light-transmitting unit. The substrate unit has a bottom substrate, a middle substrate extended upwards from one end of the bottom substrate, and a top substrate extended outwards from one end of the middle substrate and corresponding to the bottom substrate. The top substrate has a light-transmitting region. The image-capturing unit has at least one image-capturing element electrically disposed on the bottom substrate. The optical imaging unit is disposed on the bottom substrate and covers the image-capturing unit. The light-emitting unit has at least one light-emitting element electrically disposed on the top substrate and above the optical imaging unit. The light-transmitting unit has a light-transmitting element disposed on the top substrate and adjacent to the light-emitting unit, and an object is disposed on the light-transmitting element.

### BACKGROUND OF THE INVENTION

1. Field of the Invention

The present invention relates to an image-capturing module, in particular, to an image-capturing module with a flexible type substrate structure.

2. Description of Related Art

A personal fingerprint is a unique bio-feature different from those of others. When used as a personal secret code, it is extremely secure. Because of the popularity of electronic device and the increase of their storage capacities, the protection for personal data stored therein becomes increasingly important. Using a fingerprint for unlocking electronic device or as a secret code can make management of personal data more efficient. Electronic device such as a mobile phone, a computer host, and various kinds of computer peripherals can make use of a fingerprint scanning device to capture a user's fingerprint for identity confirmation. After the fingerprint image in the fingerprint scanning device is converted into digital fingerprint information, it is easy to transmit the digital fingerprint information to a controller in the electronic device to exploit fully the effect of fingerprint identification.

Referring to FIG. 1, the prior art provides an image-capturing module including a PCB P, an image sensor S electrically disposed on the PCB P, an LED D electrically disposed on the PCB P, a condensing lens G disposed above the image sensor S, and a light-guiding element T disposed above the LED D. The image capturing process of the prior art is shown as follows: (1) light beams L generated by the LED D are guided by the light-guiding element T to form a projecting light beams L′ that project onto the object F above the condensing lens G; next (2) the projecting light beams L′ are reflected by the object F to form reflecting light beams L″ that project onto the condensing lens G; and then (3) the reflecting light beams L″ pass through the condensing lens G and project onto the image sensor S in order to capture the image information of one surface of the object F.

### SUMMARY OF THE INVENTION

In view of the aforementioned issues, the present invention provides an image-capturing module with a flexible type substrate structure. The present invention provides a substrate unit that may be bent in order to make an image-capturing unit and a light-emitting unit disposed on the different planes.

To achieve the above-mentioned objectives, the present invention provides an image-capturing module with a flexible type substrate structure, including: a substrate unit, an image-capturing unit, an optical imaging unit, a light-emitting unit and a light-transmitting unit. The substrate unit has a bottom substrate, a middle substrate extended upwards from one end of the bottom substrate, and a top substrate extended outwards from one end of the middle substrate and corresponding to the bottom substrate, and the top substrate has a light-transmitting region. The image-capturing unit has at least one image-capturing element electrically disposed on the bottom substrate. The optical imaging unit is disposed on the bottom substrate and covers the image-capturing unit. The light-emitting unit has at least one light-emitting element electrically disposed on the top substrate and above the optical imaging unit. The light-transmitting unit has a light-transmitting element disposed on the top substrate and adjacent to the light-emitting unit, and an object is disposed on the light-transmitting element.

Therefore, light beams generated by the at least one light-emitting element are projected onto the light-transmitting element, then the light beams are guided to project onto the object by the light-transmitting element, next the light beams are reflected by the object to form a reflected light beams that are projected onto the optical imaging unit, and then the reflected light beams pass through the optical image unit and project onto the image-capturing unit.

To achieve the above-mentioned objectives, the present invention provides an image-capturing module with a flexible type substrate structure, including: a substrate unit, an image-capturing unit, an optical imaging unit, a light-emitting unit and a light-transmitting unit. The substrate unit has a bottom substrate, a middle substrate extended upwards from one end of the bottom substrate, and a top substrate extended outwards from one end of the middle substrate and corresponding to the bottom substrate. The top substrate has a light-transmitting region, and the bottom substrate is a light-transmitting substrate. The image-capturing unit has at least one image-capturing element electrically disposed on the bottom substrate. The optical imaging unit is disposed on the bottom substrate and covers the image-capturing unit. The light-emitting unit has at least one light-emitting element electrically disposed on the top substrate and above the optical imaging unit. The light-transmitting unit has a light-transmitting element disposed on the top substrate and adjacent to the light-emitting unit, and an object is disposed on the light-transmitting element.

Therefore, light beams generated by the at least one light-emitting element are projected onto the light-transmitting element, then the light beams are guided to project onto the object by the light-transmitting element, next the light beams are reflected by the object to form a reflected light beams that are projected onto the optical imaging unit, and then the reflected light beams pass through the optical image unit and the bottom substrate and project onto the image-capturing unit.

In order to further understand the techniques, means and effects the present invention takes for achieving the prescribed objectives, the following detailed descriptions and appended drawings are hereby referred, such that, through which, the purposes, features and aspects of the present invention may be thoroughly and concretely appreciated; however, the appended drawings are provided solely for reference and illustration, without any intention that they be used for limiting the present invention.

### BRIEF DESCRIPTION OF THE DRAWINGS

FIG. 1 is a schematic view of the image-capturing module according to the prior art;

FIG. 2 is a cross-sectional, schematic view of the image-capturing module according to the first embodiment of the present invention;

FIG. 3 is a cross-sectional, schematic view of the image-capturing module according to the second embodiment of the present invention;

FIG. 4 is a cross-sectional, schematic view of the image-capturing module according to the third embodiment of the present invention;

FIG. 5 is a cross-sectional, schematic view of the image-capturing module according to the fourth embodiment of the present invention;

FIG. 5A is a cross-sectional, schematic view of the image-capturing module according to another fourth embodiment of the present invention;

FIG. 5B is a cross-sectional, schematic view of the image-capturing module according to the other fourth embodiment of the present invention;

FIG. 6 is a cross-sectional, schematic view of the image-capturing module according to the fifth embodiment of the present invention;

FIG. 7 is a cross-sectional, schematic view of the image-capturing module according to the sixth embodiment of the present invention;

FIG. 8 is a cross-sectional, schematic view of the image-capturing module according to the seventh embodiment of the present invention;

FIG. 9 is a cross-sectional, schematic view of the image-capturing module according to the eighth embodiment of the present invention;

FIG. 9A is a cross-sectional, schematic view of the image-capturing module according to another eighth embodiment of the present invention; and

FIG. 9B is a cross-sectional, schematic view of the image-capturing module according to the other eighth embodiment of the present invention.

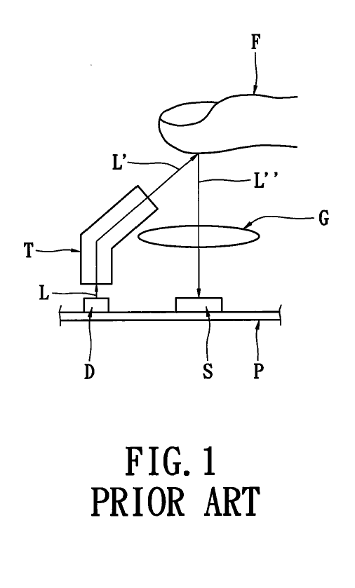

### DETAILED DESCRIPTION OF THE PREFERRED EMBODIMENTS

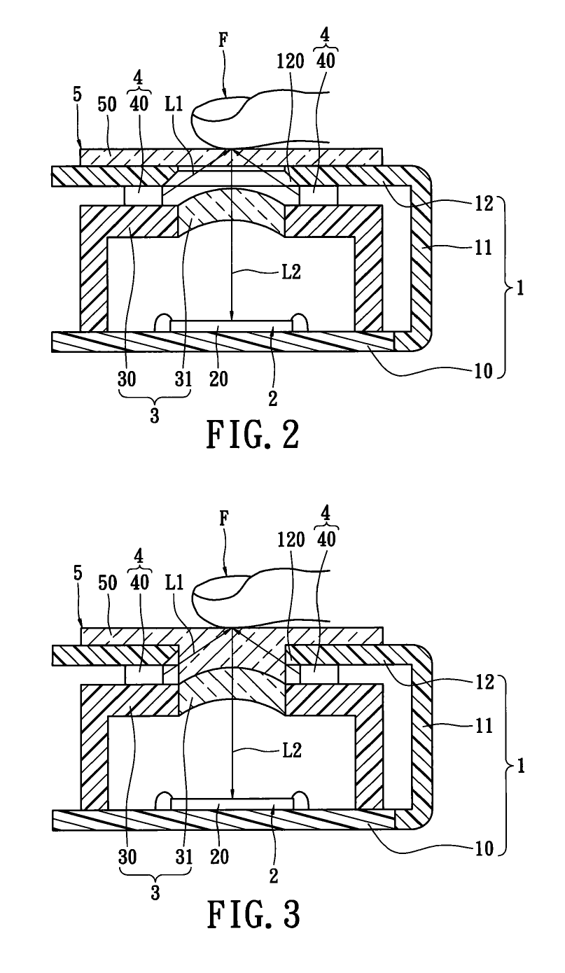

Referring to FIG. 2, the first embodiment of the present invention provides an image-capturing module with a flexible type substrate structure, including: a substrate unit 1, an image-capturing unit 2, an optical imaging unit 3, a light-emitting unit 4 and a light-transmitting unit 5.

The substrate unit 1 has a bottom substrate 10, a middle substrate 11 extended upwards from one end of the bottom substrate 10, and a top substrate 12 extended outwards from one end of the middle substrate 11 and corresponding to the bottom substrate 10. The middle substrate 11 and the top substrate 12 may be integrally combined to form one piece. The top substrate 12 has a light-transmitting region 120. In addition, the light-transmitting region 120 may be an opening or a light-transmitting body (for example the opening may be filled with the light-transmitting body to form the first light-transmitting region 120). In the first embodiment, the light-transmitting region 120 is an opening.

Moreover, if the light-transmitting region 120 is a light-transmitting body and the substrate unit 1 is composed of an opaque part and a light-transmitting part that is the light-transmitting region 120, the object F may be placed directly on the light-transmitting region 120 (the light-transmitting body) without using the light-transmitting unit 5.

Furthermore, the top substrate 12 and the bottom substrate 10 are extended from the middle substrate 11 along the same direction, so that the substrate unit 1 is formed as a U shape. In addition, the substrate unit 1 may be a flexible substrate, or the bottom substrate 10 may be a hard substrate and the middle substrate 11 and the top substrate 12 may be flexible substrates, according to different requirements. In the first embodiment, the bottom substrate 10 is a hard substrate, and the middle substrate 11 and the top substrate 12 are flexible substrates. Hence, the middle substrate 11 and the top substrate 12 may be bent according to different requirements.

Furthermore, the image-capturing unit 2 has at least one image-capturing element 20 electrically disposed on the bottom substrate 10, so that the number of the image-capturing element 20 may be adjustable according to different requirements. The image-capturing element 20 may be an image sensor, and the image-capturing element 20 can electrically connect to analysis software in computer in order to read image information that is captured by the image-capturing element 20.

In addition, the optical imaging unit 3 with anti stray light function is disposed on the bottom substrate 10 and covers the image-capturing unit 2. In the first embodiment, the optical imaging unit 3 has a shading body 30 (for example, a shading layer is coated on the external surface of the shading body 30 in order to achieve anti stray light function) and a condensing element 31 jointed with the shading body 30 and disposed above the image-capturing unit 2. The condensing element 31 may be a condensing lens for condensing light beams, and the shading body 30 and the condensing element 31 may be integrally formed in one piece. Hence, the light beams are projected onto the image-capturing element 20 along a predetermined path by using the optical image unit 3 (it means the optical image unit 3 can shade other external stray light), so that the image-capturing element 20 can obtain correct image information.

Furthermore, the light-emitting unit 4 has at least one light-emitting element 40 electrically disposed on the top substrate 12 and above the optical imaging unit 3, and the light-emitting element 40 may be an LED. In the first embodiment, the light-emitting unit 4 provides two light-emitting elements 40 electrically disposed on the top substrate 12. However, the above-mentioned number of the light-emitting element 40 is just an example in the first embodiment, and any type of light-emitting element may be applied to the present invention.

Moreover, the light-transmitting unit 5 has a light-transmitting element 50 (such as transparent glass or plastic) disposed on the top substrate 12 and adjacent to the light-emitting unit 4, and the object F is disposed on the light-transmitting element 50. In other words, the sensing surface of the object F (such as fingerprint of finger) may be disposed on the light-transmitting element 50 to be sensed. In addition, the light-transmitting element 50 and the condensing element 31 may be connected to each other or be integrally combined to form one piece.

Hence, the feature of the first embodiment as shown in FIG. 2 is that: the light-emitting unit 4 and the light-transmitting unit 5 are respectively disposed on two opposite surfaces of the top substrate 12, and the light-emitting unit 4 is disposed between the optical imaging unit 3 and the top substrate 12. In other words, the top substrate 12 is positioned above the optical imaging unit 3 by the two light-emitting elements 40 or any fixing blocks on the optical imaging unit 3.

Therefore, the light beams L1 generated by the two light-emitting elements 40 are projected onto the light-transmitting element 50 (the light beams L1 pass through the light-transmitting region 120), then the light beams L1 are guided to project onto the object F by the light-transmitting element 50, next the light beams L1 are reflected by the object F to form a reflected light beams L2 that are projected onto the optical imaging unit 3 (the reflected light beams L2 pass through the light-transmitting region 120), and then the reflected light beams L2 pass through the optical image unit 3 and project onto the image-capturing unit 2 in order capture the image information of one surface of the object F.

Referring to FIG. 3, the second embodiment of the present invention provides an image-capturing module with a flexible type substrate structure, including: a substrate unit 1, an image-capturing unit 2, an optical imaging unit 3, a light-emitting unit 4 and a light-transmitting unit 5. The difference between the second embodiment and the first embodiment is that: in the second embodiment, the light-transmitting element 50 has a bottom portion passing through the light-transmitting region 120 and contacting the optical imaging unit 3 or passing through light-transmitting region 120 and disposed above the optical imaging unit 3 without contacting the optical imaging unit 3. In addition, the light-transmitting element 50 and the condensing element 31 may be connected to each other or be integrally combined to form one piece.

Therefore, the light beams L1 generated by the two light-emitting elements 40 are projected onto the light-transmitting element 50 (the light beams L1 pass through the light-transmitting region 120), then the light beams L1 are guided to project onto the object F by the light-transmitting element 50, next the light beams L1 are reflected by the object F to form a reflected light beams L2 that are projected onto the optical imaging unit 3 (the reflected light beams L2 pass through the light-transmitting region 120), and then the reflected light beams L2 pass through the optical image unit 3 and project onto the image-capturing unit 2 in order capture the image information of one surface of the object F.

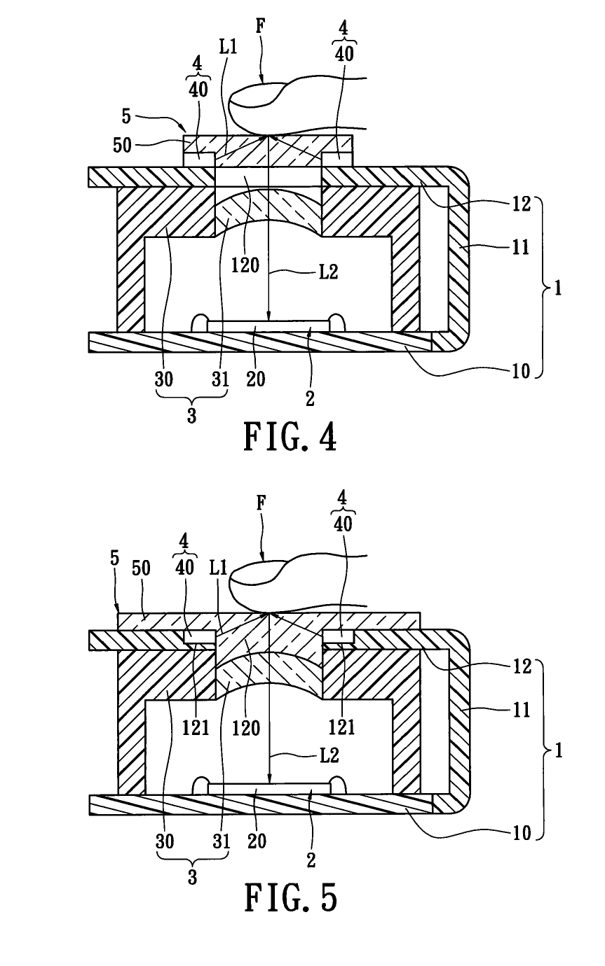

Referring to FIG. 4, the third embodiment of the present invention provides an image-capturing module with a flexible type substrate structure, including: a substrate unit 1, an image-capturing unit 2, an optical imaging unit 3, a light-emitting unit 4 and a light-transmitting unit 5. The difference between the third embodiment and the above-mentioned embodiments is that: in the third embodiment, the light-emitting unit 4 and the light-transmitting unit 5 both are disposed on an outer surface of the top substrate 12, the light-emitting unit 4 is disposed between the light-transmitting unit 5 and the top substrate 12, and the top substrate 12 is directly disposed on the optical imaging unit 3. In addition, the light-transmitting element 50 and the condensing element 31 may be connected to each other or be integrally combined to form one piece.

Therefore, the light beams L1 generated by the two light-emitting elements 40 are projected onto the light-transmitting element 50, then the light beams L1 are guided to project onto the object F by the light-transmitting element 50, next the light beams L1 are reflected by the object F to form a reflected light beams L2 that are projected onto the optical imaging unit 3 (the reflected light beams L2 pass through the light-transmitting region 120), and then the reflected light beams L2 pass through the optical image unit 3 and project onto the image-capturing unit 2 in order capture the image information of one surface of the object F.

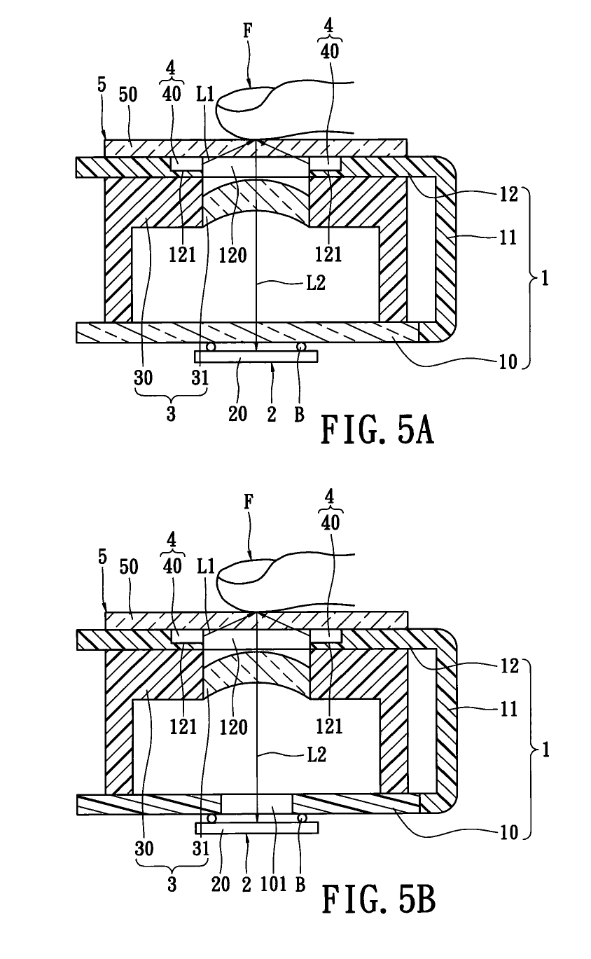

Referring to FIG. 5, the fourth embodiment of the present invention provides an image-capturing module with a flexible type substrate structure, including: a substrate unit 1, an image-capturing unit 2, an optical imaging unit 3, a light-emitting unit 4 and a light-transmitting unit 5. The difference between the fourth embodiment and the third embodiment is that: in the third embodiment, the top substrate 12 has two grooves 121 formed on an outer surface thereof, the two light-emitting elements 40 of the light-emitting unit 4 are respectively received in the two grooves 121, and the light-transmitting unit 5 is disposed on the external surface of the top substrate 12 and covers the light-emitting unit 4. In addition, the light-transmitting element 50 and the condensing element 31 may be connected to each other or be integrally combined to form one piece.

Therefore, the light beams L1 generated by the two light-emitting elements 40 are projected onto the light-transmitting element 50, then the light beams L1 are guided to project onto the object F by the light-transmitting element 50, next the light beams L1 are reflected by the object F to form a reflected light beams L2 that are projected onto the optical imaging unit 3 (the reflected light beams L2 pass through the light-transmitting region 120), and then the reflected light beams L2 pass through the optical image unit 3 and project onto the image-capturing unit 2 in order capture the image information of one surface of the object F.

Referring to FIG. 5A, another fourth embodiment of the present invention provides an image-capturing module with a flexible type substrate structure, including: a substrate unit 1, an image-capturing unit 2, an optical imaging unit 3, a light-emitting unit 4 and a light-transmitting unit 5. The difference between another fourth embodiment and the fourth embodiment (as shown in FIG. 5) is that: in another fourth embodiment, the bottom substrate 10 is a light-transmitting substrate, and the image-capturing element 20 of the image-capturing unit 2 is electrically disposed on the bottom substrate 10 via a plurality of conductive elements B such as solder balls by a flip-chip method. In addition, the light-transmitting element 50 and the condensing element 31 may be connected to each other or be integrally combined to form one piece.

Therefore, the light beams L1 generated by the two light-emitting elements 40 are projected onto the light-transmitting element 50, then the light beams L1 are guided to project onto the object F by the light-transmitting element 50, next the light beams L1 are reflected by the object F to form a reflected light beams L2 that are projected onto the optical imaging unit 3 (the reflected light beams L2 pass through the light-transmitting region 120), and then the reflected light beams L2 pass through the optical image unit 3 and the bottom substrate 10 and project onto the image-capturing unit 2 in order capture the image information of one surface of the object F.

Referring to FIG. 5B, the other fourth embodiment of the present invention provides an image-capturing module with a flexible type substrate structure, including: a substrate unit 1, an image-capturing unit 2, an optical imaging unit 3, a light-emitting unit 4 and a light-transmitting unit 5. The difference between the other fourth embodiment and the fourth embodiment (as shown in FIG. 5) is that: in the other fourth embodiment, the bottom substrate 10 has an opening 101, and the image-capturing element 20 of the image-capturing unit 2 is electrically disposed on the bottom substrate 10 via a plurality of conductive elements B such as solder balls by a flip-chip method. In addition, the light-transmitting element 50 and the condensing element 31 may be connected to each other or be integrally combined to form one piece.

Therefore, the light beams L1 generated by the two light-emitting elements 40 are projected onto the light-transmitting element 50, then the light beams L1 are guided to project onto the object F by the light-transmitting element 50, next the light beams L1 are reflected by the object F to form a reflected light beams L2 that are projected onto the optical imaging unit 3 (the reflected light beams L2 pass through the light-transmitting region 120), and then the reflected light beams L2 pass through the optical image unit 3 and the opening 101 of the bottom substrate 10 and project onto the image-capturing unit 2 in order capture the image information of one surface of the object F.

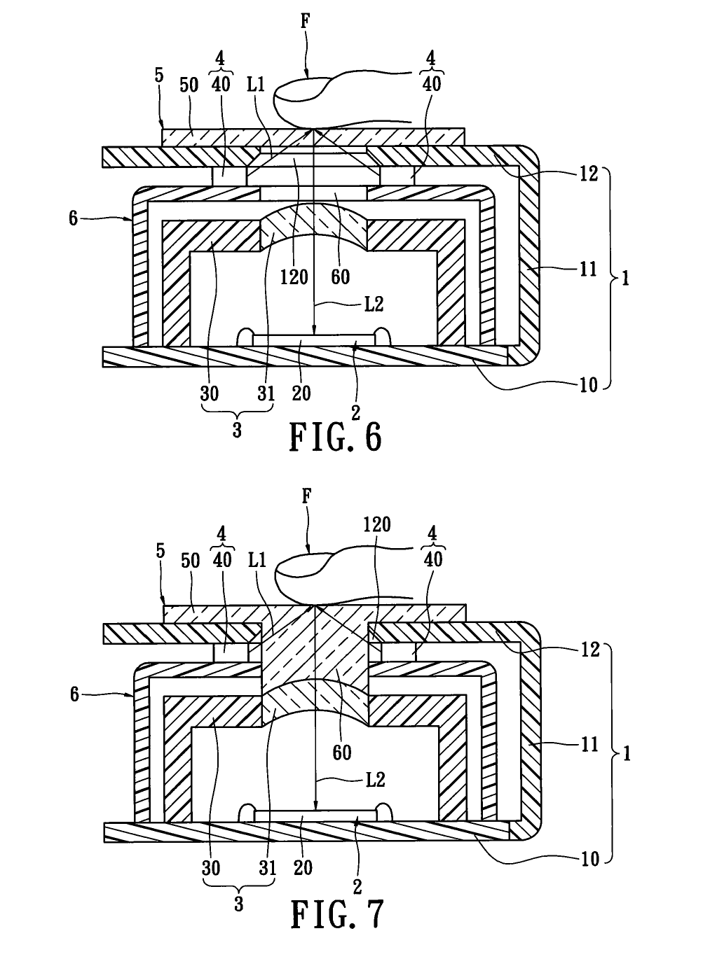

Referring to FIG. 6, the fifth embodiment of the present invention provides an image-capturing module with a flexible type substrate structure, including: a substrate unit 1, an image-capturing unit 2, an optical imaging unit 3, a light-emitting unit 4, a light-transmitting unit 5 and a cover unit 6.

The substrate unit 1 has a bottom substrate 10, a middle substrate 11 extended upwards from one end of the bottom substrate 10, and a top substrate 12 extended outwards from one end of the middle substrate 11 and corresponding to the bottom substrate 10. The top substrate 12 has a light-transmitting region 120. In addition, the light-transmitting region 120 may be an opening or a light-transmitting body (for example the opening may be filled with the light-transmitting body to form the first light-transmitting region 120). In the fifth embodiment, the light-transmitting region 120 is an opening.

Moreover, if the light-transmitting region 120 is a light-transmitting body and the substrate unit 1 is composed of an opaque part and a light-transmitting part that is the light-transmitting region 120, the object F may be placed directly on the light-transmitting region 120 (the light-transmitting body) without using the light-transmitting unit 5.

Furthermore, the top substrate 12 and the bottom substrate 10 are extended from the middle substrate 11 along the same direction, so that the substrate unit 1 is formed as a U shape. In addition, the substrate unit 1 may be a flexible substrate, or the bottom substrate 10 may be a hard substrate and the middle substrate 11 and the top substrate 12 may be flexible substrates, according to different requirements. In the first embodiment, the bottom substrate 10 is a hard substrate, and the middle substrate 11 and the top substrate 12 are flexible substrates. Hence, the middle substrate 11 and the top substrate 12 may be bent according to different requirements.

The substrate unit has a bottom substrate 10 and a top substrate 12 disposed above the bottom substrate 10 and corresponding to the bottom substrate 10, and the bottom substrate 10 and the top substrate 12 are separated from each other by a predetermined distance. The top substrate 12 has a first light-transmitting region 120, and the first light-transmitting region 120 may be an opening or a light-transmitting body (for example the opening may be filled with the light-transmitting body to form the first light-transmitting region 120). In the first embodiment, the first light-transmitting region 120 is an opening. In addition, the bottom substrate 10 may be a hard substrate and the top substrate 12 may be a flexible substrate, or the bottom substrate 10 may be a hard substrate and the top substrate 12 may be a hard substrate, according to different requirements. In the first embodiment, the bottom substrate 10 and the top substrate 12 both are hard substrates.

Moreover, if the first light-transmitting region 120 is a light-transmitting body and the substrate unit 1 is composed of an opaque part and a light-transmitting part that is the first light-transmitting region 120, the object F may be placed directly on the first light-transmitting region 120 (the light-transmitting body) without using the light-transmitting unit 5.

Furthermore, the image-capturing unit 2 has at least one image-capturing element 20 electrically disposed on the bottom substrate 10, so that the number of the image-capturing element 20 may be adjustable according to different requirements. The image-capturing element 20 may be an image sensor, and the image-capturing element 20 can electrically connect to analysis software in computer in order to read image information that is captured by the image-capturing element 20.

In addition, the optical imaging unit 3 with anti stray light function is disposed on the bottom substrate 10 and covers the image-capturing unit 2. In the first embodiment, the optical imaging unit 3 has a shading body 30 (for example, a shading layer is coated on the external surface of the shading body 30 in order to achieve anti stray light function) and a condensing element 31 jointed with the shading body 30 and disposed above the image-capturing unit 2. The condensing element 31 may be a condensing lens for condensing light beams, and the shading body 30 and the condensing element 31 may be integrally formed in one piece. Hence, the light beams are projected onto the image-capturing element 20 along a predetermined path by using the optical image unit 3 (it means the optical image unit 3 can shade other external stray light), so that the image-capturing element 20 can obtain correct image information.

Furthermore, the light-emitting unit 4 has at least one light-emitting element 40 electrically disposed on the top substrate 12 and above the cover unit 6, and the light-emitting element 40 may be an LED. In the first embodiment, the light-emitting unit 4 provides two light-emitting elements 40 electrically disposed on the top substrate 12. However, the above-mentioned number of the light-emitting element 40 is just an example in the fifth embodiment, and any type of light-emitting element may be applied to the present invention.

Moreover, the light-transmitting unit 5 has a light-transmitting element 50 (such as transparent glass or plastic) disposed on the top substrate 12 and adjacent to the light-emitting unit 4, and the object F is disposed on the light-transmitting element 50. In other words, the sensing surface of the object F (such as fingerprint of finger) may be disposed on the light-transmitting element 50 to be sensed. In addition, the light-transmitting element 50 and the condensing element 31 may be connected to each other or be integrally combined to form one piece.

Besides, the cover unit 6 is disposed on the bottom substrate 10 and covers the image-capturing unit 3, and the cover unit 6 has a second light-transmitting region 60 corresponding to the first light-transmitting region 120. The second light-transmitting region 60 may be an opening or a light-transmitting body (for example the opening may be filled with the light-transmitting body to form the second light-transmitting region 60). In the fifth embodiment, the second light-transmitting region 60 is an opening.

Hence, the feature of the fifth embodiment as shown in FIG. 6 is that: the light-emitting unit 4 and the light-transmitting unit 5 are respectively disposed on two opposite surfaces of the top substrate 12, and the light-emitting unit 4 is disposed between the optical imaging unit 3 and the top substrate 12. In other words, the top substrate 12 is positioned above the cover unit 6 by the two light-emitting elements 40 or any fixing blocks on the optical imaging unit 3.

Therefore, the light beams L1 generated by the two light-emitting elements 40 are projected onto the light-transmitting element 50 (the light beams L1 pass through the first light-transmitting region 120), then the light beams L1 are guided to project onto the object F by the light-transmitting element 50, next the light beams L1 are reflected by the object F to form a reflected light beams L2 that are projected onto the optical imaging unit 3, and then the reflected light beams L2 pass through the cover unit 6 and the optical image unit 3 (the reflected light beams L2 pass through the first light-transmitting region 120, the second light-transmitting region 60 and the condensing element 31 in sequence) and project onto the image-capturing unit 2 in order capture the image information of one surface of the object F.

Referring to FIG. 7, the sixth embodiment of the present invention provides an image-capturing module with a flexible type substrate structure, including: a substrate unit 1, an image-capturing unit 2, an optical imaging unit 3, a light-emitting unit 4, a light-transmitting unit 5 and a cover unit 6. The difference between the sixth embodiment and the fifth embodiment is that: in the sixth embodiment, the light-transmitting element 50 has a bottom portion passing through the first light-transmitting region 120 and disposed above the cover unit 6. In addition, the light-transmitting element 50 and the condensing element 31 may be connected to each other or be integrally combined to form one piece.

Therefore, the light beams L1 generated by the two light-emitting elements 40 are projected onto the light-transmitting element 50 (the light beams L1 pass through the first light-transmitting region 120), then the light beams L1 are guided to project onto the object F by the light-transmitting element 50, next the light beams L1 are reflected by the object F to form a reflected light beams L2 that are projected onto the optical imaging unit 3, and then the reflected light beams L2 pass through the cover unit 6 and the optical image unit 3 (the reflected light beams L2 pass through the first light-transmitting region 120, the second light-transmitting region 60 and the condensing element 31 in sequence) and project onto the image-capturing unit 2 in order capture the image information of one surface of the object F.

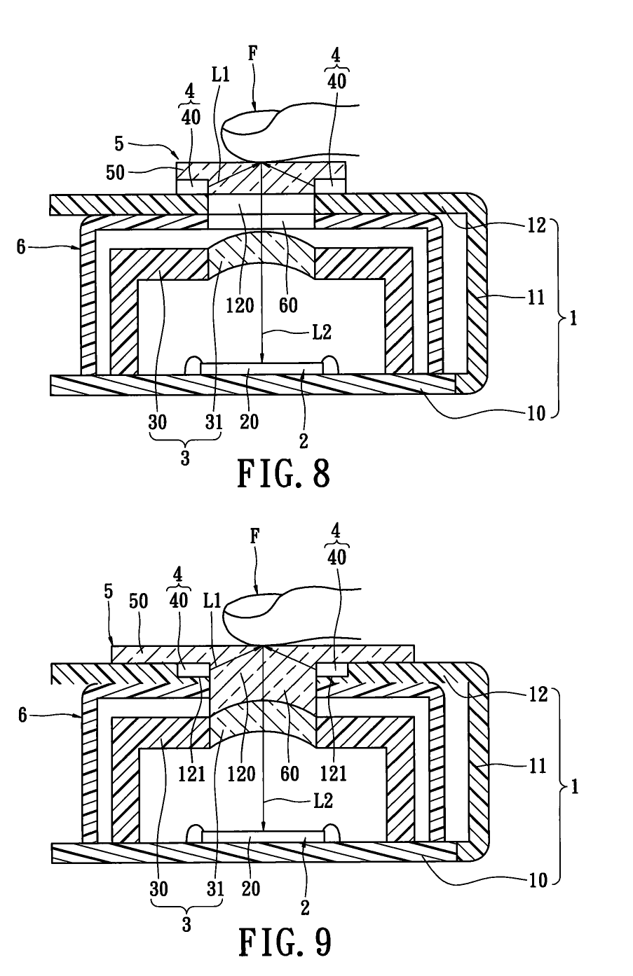

Referring to FIG. 8, the seventh embodiment of the present invention provides an image-capturing module with a flexible type substrate structure, including: a substrate unit 1, an image-capturing unit 2, an optical imaging unit 3, a light-emitting unit 4, a light-transmitting unit 5 and a cover unit 6. The difference between the seventh embodiment and the fifth and sixth embodiments is that: in the seventh embodiment, the light-emitting unit 4 and the light-transmitting unit 5 both are disposed on an outer surface of the top substrate 12, the light-emitting unit 4 is disposed between the light-transmitting unit 5 and the top substrate 12, and the top substrate 12 is directly disposed on the cover unit 6. In addition, the light-transmitting element 50 and the condensing element 31 may be connected to each other or be integrally combined to form one piece.

Therefore, the light beams L1 generated by the two light-emitting elements 40 are projected onto the light-transmitting element 50, then the light beams L1 are guided to project onto the object F by the light-transmitting element 50, next the light beams L1 are reflected by the object F to form a reflected light beams L2 that are projected onto the optical imaging unit 3, and then the reflected light beams L2 pass through the cover unit 6 and the optical image unit 3 (the reflected light beams L2 pass through the first light-transmitting region 120, the second light-transmitting region 60 and the condensing element 31 in sequence) and project onto the image-capturing unit 2 in order capture the image information of one surface of the object F.

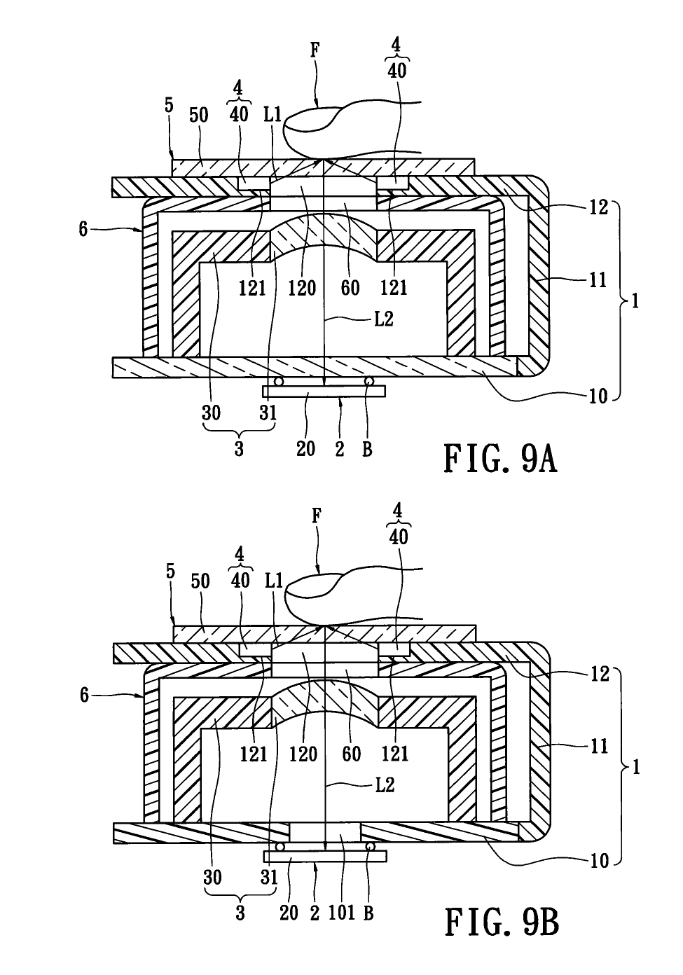

Referring to FIG. 9, the eighth embodiment of the present invention provides an image-capturing module with a flexible type substrate structure, including: a substrate unit 1, an image-capturing unit 2, an optical imaging unit 3, a light-emitting unit 4, a light-transmitting unit 5 and a cover unit 6. The difference between the eighth embodiment and the seventh embodiment is that: in the eighth embodiment, the top substrate 12 has two grooves 121 formed on an outer surface thereof, the two light-emitting elements 40 of the light-emitting unit 4 are respectively received in the two grooves 121, and the light-transmitting unit 5 is disposed on the external surface of the top substrate 12 and covers the light-emitting unit 4. In addition, the light-transmitting element 50 and the condensing element 31 may be connected to each other or be integrally combined to form one piece.

Therefore, the light beams L1 generated by the two light-emitting elements 40 are projected onto the light-transmitting element 50, then the light beams L1 are guided to project onto the object F by the light-transmitting element 50, next the light beams L1 are reflected by the object F to form a reflected light beams L2 that are projected onto the optical imaging unit 3, and then the reflected light beams L2 pass through the cover unit 6 and the optical image unit 3 (the reflected light beams L2 pass through the first light-transmitting region 120, the second light-transmitting region 60 and the condensing element 31 in sequence) and project onto the image-capturing unit 2 in order capture the image information of one surface of the object F.

Referring to FIG. 9A, another eighth embodiment of the present invention provides an image-capturing module with a flexible type substrate structure, including: a substrate unit 1, an image-capturing unit 2, an optical imaging unit 3, a light-emitting unit 4, a light-transmitting unit 5 and a cover unit 6. The difference between another eighth embodiment and the eighth embodiment (as shown in FIG. 9) is that: in another eighth embodiment, the bottom substrate 10 is a light-transmitting substrate, and the image-capturing element 20 of the image-capturing unit 2 is electrically disposed on the bottom substrate 10 via a plurality of conductive elements B such as solder balls by a flip-chip method. In addition, the light-transmitting element 50 and the condensing element 31 may be connected to each other or be integrally combined to form one piece.

Therefore, the light beams L1 generated by the two light-emitting elements 40 are projected onto the light-transmitting element 50, then the light beams L1 are guided to project onto the object F by the light-transmitting element 50, next the light beams L1 are reflected by the object F to form a reflected light beams L2 that are projected onto the optical imaging unit 3, and then the reflected light beams L2 pass through the cover unit 6, the optical image unit 3 and the bottom substrate 10 (the reflected light beams L2 pass through the first light-transmitting region 120, the second light-transmitting region 60 and the condensing element 31 in sequence) and project onto the image-capturing unit 2 in order capture the image information of one surface of the object F.

Referring to FIG. 9B, the other eighth embodiment of the present invention provides an image-capturing module with a flexible type substrate structure, including: a substrate unit 1, an image-capturing unit 2, an optical imaging unit 3, a light-emitting unit 4, a light-transmitting unit 5 and a cover unit 6. The difference between the other eighth embodiment and the eighth embodiment (as shown in FIG. 9) is that: in the other eighth embodiment, the bottom substrate 10 has an opening 101, and the image-capturing element 20 of the image-capturing unit 2 is electrically disposed on the bottom substrate 10 via a plurality of conductive elements B such as solder balls by a flip-chip method. In addition, the light-transmitting element 50 and the condensing element 31 may be connected to each other or be integrally combined to form one piece.

Therefore, the light beams L1 generated by the two light-emitting elements 40 are projected onto the light-transmitting element 50, then the light beams L1 are guided to project onto the object F by the light-transmitting element 50, next the light beams L1 are reflected by the object F to form a reflected light beams L2 that are projected onto the optical imaging unit 3, and then the reflected light beams L2 pass through the cover unit 6, the optical image unit 3 and the bottom substrate 10 (the reflected light beams L2 pass through the first light-transmitting region 120, the second light-transmitting region 60, the condensing element 31 and the opening 101 in sequence) and project onto the image-capturing unit 2 in order capture the image information of one surface of the object F.

Furthermore, the light-transmitting element 50 may be design as a lens for transmitting light beams L1 to the image-capturing unit 2.

The above-mentioned descriptions merely represent solely the preferred embodiments of the present invention, without any intention or ability to limit the scope of the present invention which is fully described only within the following claims. Various equivalent changes, alterations or modifications based on the claims of present invention are all, consequently, viewed as being embraced by the scope of the present invention.

What is claimed is:

1. An image-capturing module with a flexible type substrate structure, comprising:
a substrate unit having a bottom substrate, a middle substrate extended upwards from one end of the bottom substrate, and a top substrate extended outwards from one end of the middle substrate and corresponding to the bottom substrate, wherein the top substrate has a light-transmitting region;
an image-capturing unit having at least one image-capturing element electrically disposed on the bottom substrate;
an optical imaging unit disposed on the bottom substrate and covering the image-capturing unit;
a light-emitting unit having at least one light-emitting element electrically disposed on the top substrate and above the optical imaging unit; and
a light-transmitting unit having a light-transmitting element disposed on the top substrate and adjacent to the light-emitting unit, wherein an object is disposed on the light-transmitting element;
whereby, light beams generated by the at least one light-emitting element are projected onto the light-transmitting element, then the light beams are guided to project onto the object by the light-transmitting element, next the light beams are reflected by the object to form a reflected light beams that are projected onto the optical imaging unit, and then the reflected light beams pass through the optical image unit and project onto the image-capturing unit.

2. The image-capturing module according to claim 1, wherein the top substrate and the bottom substrate are extended from the middle substrate along the same direction, so that the substrate unit is formed as a U shape.

3. The image-capturing module according to claim 1, wherein the substrate unit is a flexible substrate.

4. The image-capturing module according to claim 1, wherein the bottom substrate is a hard substrate, and the middle substrate and the top substrate are flexible substrates.

5. The image-capturing module according to claim 1, wherein the light-transmitting region of the top substrate is an opening or a light-transmitting body.

6. The image-capturing module according to claim 1, wherein the light-emitting unit and the light-transmitting unit are respectively disposed on two opposite surfaces of the top substrate, and the light-emitting unit is disposed between the optical imaging unit and the top substrate.

7. The image-capturing module according to claim 1, wherein the light-emitting unit and the light-transmitting unit are respectively disposed on two opposite surfaces of the top substrate, the light-transmitting element has a bottom portion passing through the light-transmitting region and contacting the optical imaging unit, and the light-emitting unit is disposed between the optical imaging unit and the top substrate.

8. The image-capturing module according to claim 1, wherein the light-emitting unit and the light-transmitting unit both are disposed on an outer surface of the top substrate, the light-emitting unit is disposed between the light-transmitting unit and the top substrate, and the top substrate is disposed on the optical imaging unit.

9. The image-capturing module according to claim 1, wherein the top substrate has at least one groove formed on an outer surface thereof, the light-emitting unit is received in the at least one groove, the light-transmitting unit is disposed on the external surface of the top substrate and covers the light-emitting unit, and the top substrate is disposed on the optical imaging unit.

10. The image-capturing module according to claim 1, wherein the optical imaging unit has a shading body and a condensing element jointed with the shading body and disposed above the image-capturing unit.

11. An image-capturing module with a flexible type substrate structure, comprising:
a substrate unit having a bottom substrate, a middle substrate extended upwards from one end of the bottom substrate, and a top substrate extended outwards from one end of the middle substrate and corresponding to the bottom substrate, wherein the top substrate has a light-transmitting region, and the bottom substrate is a light-transmitting substrate;
an image-capturing unit having at least one image-capturing element electrically disposed on the bottom substrate;
an optical imaging unit disposed on the bottom substrate and covering the image-capturing unit;
a light-emitting unit having at least one light-emitting element electrically disposed on the top substrate and above the optical imaging unit; and
a light-transmitting unit having a light-transmitting element disposed on the top substrate and adjacent to the light-emitting unit, wherein an object is disposed on the light-transmitting element;
whereby, light beams generated by the at least one light-emitting element are projected onto the light-transmitting element, then the light beams are guided to project onto the object by the light-transmitting element, next the light beams are reflected by the object to form a reflected light beams that are projected onto the optical imaging unit, and then the reflected light beams pass through the optical image unit and the bottom substrate and project onto the image-capturing unit.

12. The image-capturing module according to claim 11, wherein the top substrate and the bottom substrate are extended from the middle substrate along the same direction, so that the substrate unit is formed as a U shape.

13. The image-capturing module according to claim 11, wherein the substrate unit is a flexible substrate.

14. The image-capturing module according to claim 11, wherein the bottom substrate is a hard substrate, and the middle substrate and the top substrate are flexible substrates.

15. The image-capturing module according to claim 11, wherein the light-emitting unit and the light-transmitting unit both are disposed on an outer surface of the top substrate, the light-emitting unit is disposed between the light-transmitting unit and the top substrate, and the top substrate is disposed on the optical imaging unit.

16. The image-capturing module according to claim 11, wherein the top substrate has at least one groove formed on an outer surface thereof, the light-emitting unit is received in the at least one groove, the light-transmitting unit is disposed on the external surface of the top substrate and covers the light-emitting unit, and the top substrate is disposed on the optical imaging unit.
